(19) United States
(12) Patent Application Publication
(10) Pub. No.: US 2005/0151294 A1
(43) Pub. Date: Jul. 14, 2005

(54) Process of producing polyester fire-retardant core matrix for prefabricated panel

(76) Inventors: Myong Guk Jeong, Gwangju (KR); Sang Min Jung, Busan (KR); Sang Woo Lee, Gyeonggi-do (KR); Sang Woo Han, Seoul (KR); Jeong Hoon Park, Gyeonggi-do (KR); Young Tak Kang, Seoul (KR); Ki Joong Kim, Ulsan (KR)

Correspondence Address: JORDAN AND HAMBURG LLP, 122 EAST 42ND STREET, SUITE 4000, NEW YORK, NY, 10168, US

(21) Appl. No.: 10/820,377

(22) Filed: Apr. 8, 2004

(30) Foreign Application Priority Data
Apr. 11, 2003 (KR) 10-2003-0023123
Sep. 8, 2003 (KR) 10-2003-0062812

(51) Int. Cl. C08J 3/00; C08K 5/34; B29C 39/14

(52) U.S. Cl. 264/165; 264/109; 264/145

(57) ABSTRACT

Disclosed is a method of producing a polyester fire-retardant core matrix for a prefabricated panel. The method includes adding a fire-retardant agent to a polyester floss to allow the fire-retardant agent to permeate into the polyester floss, rolling the polyester floss, drenched by the fire-retardant agent, using a roller to promote permeation of the fire-retardant agent into the polyester floss, drawing the excess fire-retardant agent from the polyester floss using a perforated roller, of which an air suction force is easily controlled, drying the semi-dried polyester floss using a microwave generating unit, and foaming the dried polyester floss using a heater. The polyester fire-retardant core matrix has advantages of excellent fire-retardancy, high strength, and low absorptivity.

### BACKGROUND OF THE INVENTION

1. Field of the Invention

The present invention pertains to a fire-retardant core matrix, mostly consisting of a polyester fiber, for a prefabricated panel (sandwich panel) applied to industrial and business buildings, and a method of producing the same.

2. Description of the Prior Art

Generally, a prefabricated panel is produced by interposing a noise-absorbing or adiabatic core matrix between steel plates with a thickness of about 0.5 mm. In this regard, it is necessary to allow the core matrix to have a predetermined level of compression strength because the core matrix must ensure a structural supporting performance.

With respect to this, even though an organic foam material has an advantage of excellent compression strength, its use is gradually decreasing because of poor resistance to fire. Meanwhile, organic materials, such as polyurethane foam and Styrofoam, and inorganic materials, such as glass wools and rock wools, have been frequently used as the core matrix, but, in recent, workers evade the inorganic materials because dust occurs from the inorganic materials to harm workers' health even though the inorganic materials have excellent fire-retardancy.

Currently, a noise-absorbing and adiabatic polyester material is frequently used as a building material. Unlike other organic materials, the polyester material is advantageous in that toxic gases do not occur in combustion, and is more competitive than the inorganic material, such as glass wools and rock wools, because of its excellent workability, harmlessness, no deformation caused by a climatic change, and semi-permanent life. However, the noise-absorbing and adiabatic polyester material has a disadvantage of poor fire-retardancy, and thus, it is difficult to enlarge the use of the polyester material. To avoid the above disadvantage, efforts have been made to provide surface fire-retardancy to a polyester floss using a commercial fire-retardant dye or fireproof dye. However, such efforts are problematic in that it cannot be applied to the core matrix for the prefabricated panel, having a relatively low density of 70 kg/m³ or less and a heavy thickness of 50 mm or more, because only a highly dense panel with the low thickness of 25 mm or less and the density of 150 kg/m³ or more is produced by such efforts.

### SUMMARY OF THE INVENTION

Therefore, the present invention has been made keeping in mind the above disadvantages occurring in the prior arts, and an object of the present invention is to provide a method of producing a polyester fire-retardant core matrix for a prefabricated panel.

Leading to the present invention, the intensive and thorough research into the fire-retardant core matrix for the prefabricated panel, having excellent physical properties, carried out by the present inventors aiming to solve the problems encountered in the prior arts, resulted in the finding that the core matrix for the prefabricated panel, having excellent fire-retardancy, high strength, and low absorptivity is produced through a process of uniformly adding a fire-retardant agent into a polyester floss with a low density and a heavy thickness, a drying process, and a foaming process of the fire-retardant core matrix to improve compression strength and durability of the core matrix, thereby accomplishing the present invention.

In order to accomplish the above object, the present invention provides a method of producing a polyester fire-retardant core matrix for a prefabricated panel. The method includes a) cutting a polyester floss such that the cut polyester floss has a predetermined width, b) adding a fire-retardant agent to the cut polyester floss to allow the fire-retardant agent to permeate into the cut polyester floss, and rolling the polyester floss, drenched by the fire-retardant agent, using a roller to promote permeation of the fire-retardant agent into the polyester floss, c) removing the excess fire-retardant agent from the polyester floss, drenched by the fire-retardant agent, using a perforated roller, of which an air suction force is easily controlled, d) drying the polyester floss, drenched by the fire-retardant agent, using a drying unit, and e) heating the dried polyester floss using a heater to foam the fire-retardant agent securely attached to fiber structures of the dried polyester floss.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating the production of a polyester fire-retardant core matrix for a prefabricated panel according to the first embodiment of the present invention;

FIG. 2 is a flow chart illustrating the production of a polyester fire-retardant core matrix for a prefabricated panel according to the second embodiment of the present invention;

FIGS. 3 and 4 schematically illustrates the permeation of a fire-retardant agent into a polyester floss according to the present invention;

FIG. 5 schematically illustrates the removal of the excess fire-retardant agent from the polyester floss according to the present invention;

FIGS. 6 and 7 schematically illustrates the drying of the polyester floss according to the present invention; and

FIG. 8 schematically illustrates the foaming of the polyester floss according to the present invention.

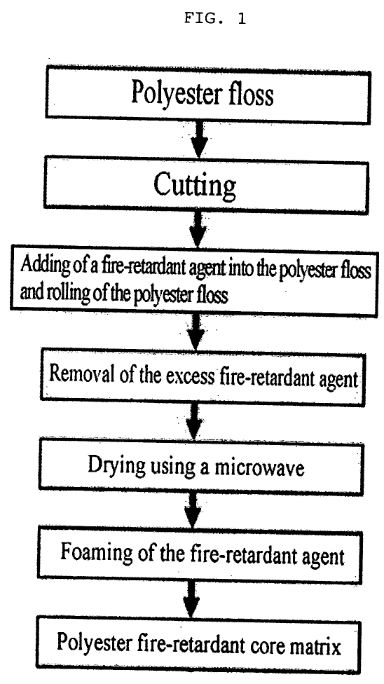

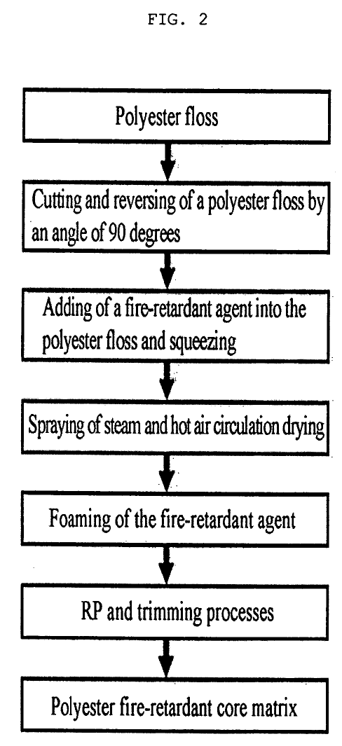

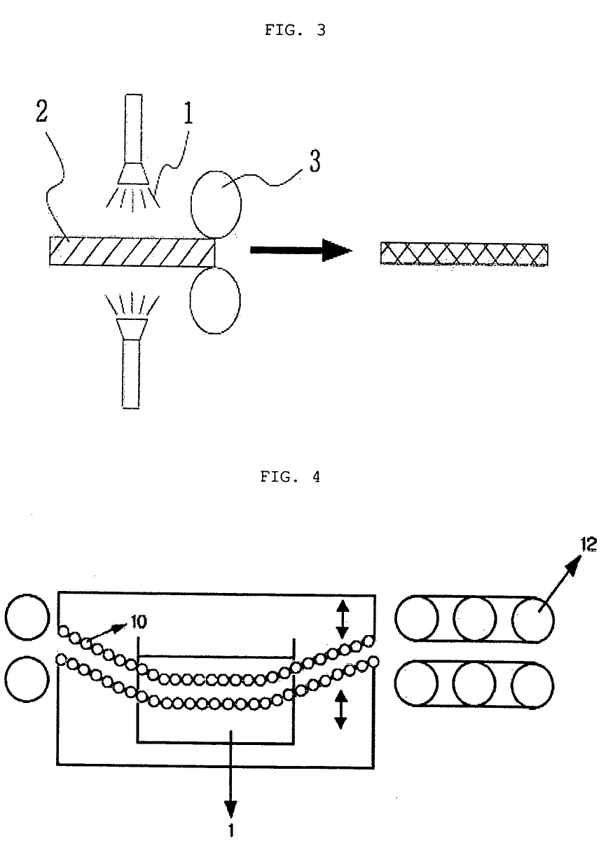

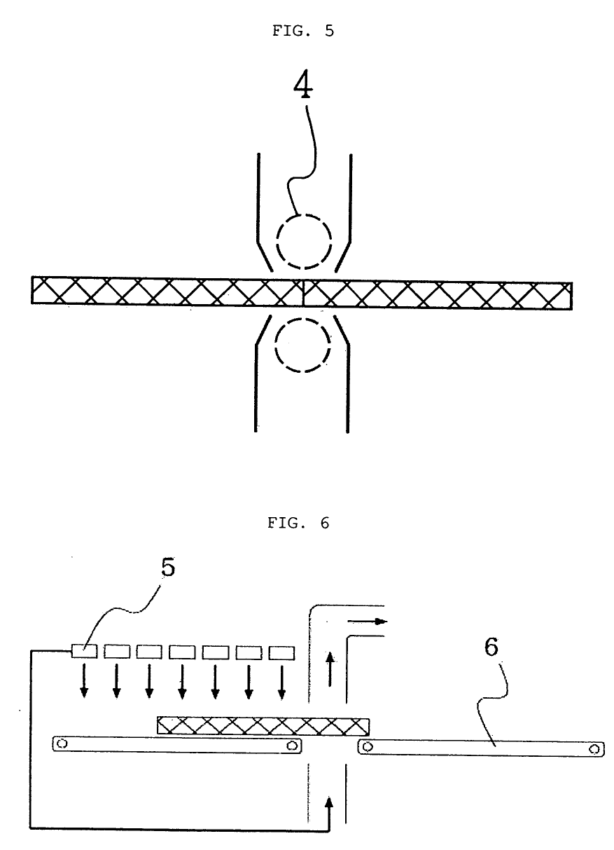

### DETAILED DESCRIPTION OF THE INVENTION

Reference now should be made to the drawings, in which the same reference numerals are used throughout the different drawings to designate the same or similar components.

According to the present invention, a low density polyester floss 2 used as a main material is cut such that the cut polyester floss 2 has a predetermined width. The cut polyester floss 2 is provided to a work table, over and under which nozzle sprays are installed, and a fire-retardant agent 1 is sprayed through the upper and lower nozzle sprays onto the cut polyester floss 2 to allow the fire-retardant agent 1 to permeate into the polyester floss 2.

In this respect, it is preferable that a disk cutter is used to cut the polyester floss, and that the width of the cut polyester floss is 50 to 100 mm. The cut polyester floss may continuously reversed by an angle of 90 degrees using a reverse device, including a pipe twisted by the angle of 90 degrees, to allow the cut polyester floss to be vertically grained, prior to being provided to the work table.

The fire-retardant agent may be added to the cut polyester floss according to a dipping process or a rolling process, instead of a spray process. To enable the fire-retardant agent to sufficiently permeate into the polyester floss, two different processes may be simultaneously applied to add the fire-retardant agent into the polyester floss. For example, the fire-retardant agent may be added to the polyester floss according to the spray process and the subsequent dipping process.

The fire-retardant agent contains 5 to 30 parts by weight of fire-retardant additive, based on 100 parts by weight of sodium silicate solution containing solids. At this time, the fire-retardant additive is selected from the group consisting of sodium phosphate monobasic, magnesium hydroxide, an ester phosphate-based compound, aluminum oxide, aluminum hydroxide, antimony oxide, molybdates, zinc tartarate, and a mixture thereof. Additionally, it is preferable that a concentration of the solids in the fire-retardant agent is 30 to 70%. For instance, when the concentration of the solids in the fire-retardant agent is less than 30%, the fire-retardant agent easily permeates into the polyester floss, but a drying load is very high in a subsequent process. When the concentration of the solids in the fire-retardant agent is more than 70%, the drying load is reduced in the subsequent process. However, uniform permeation of the fire-retardant agent into the polyester floss is not easily conducted.

At this time, the “solids” as described above is the general term for the solids contained in the sodium silicate solution and the fire-retardant additive.

After the fire-retardant agent uniformly permeates into the polyester floss, the polyester floss is subjected to a rolling process using rollers 3 to promote permeation of the fire-retardant agent into the polyester floss and to increase a density of the polyester floss. In this respect, the spraying process of the fire-retardant agent onto the polyester floss and the rolling process of the polyester floss are repeated two times or more to sufficiently permeate the fire-retardant agent into the polyester floss. As described above, if the polyester floss is subjected to the rolling process, the fire-retardant agent further easily permeates into the polyester floss in the second spraying process. Further, the excessive fire-retardant agent is removed from a surface of the polyester floss when the polyester floss is subjected to the second rolling process, thereby reducing the drying load in a subsequent drying process using air.

Preferably, the polyester floss is provided to a pipe conveyor 10, which includes a plurality of upper and lower pipes, and in which one upper pipe and one lower pipe form a pair, as shown in FIG. 4. The fire-retardant agent 1 is sprayed onto the polyester floss, or the polyester floss is dipped into the fire-retardant agent 1 in a vessel to enable the fire-retardant agent to sufficiently permeate into the polyester floss, and bubbles and the excess fire-retardant agent are firstly removed from the polyester floss at a latter part of the pipe conveyor 10 vertically vibrating. Subsequently, the excess fire-retardant agent is secondly removed from the polyester floss using three pairs of rollers 12, including three upper rollers encircled by a mesh belt and three lower rollers encircled by another mesh belt.

According to the present invention, the rolled polyester floss is subjected to a subsequent process. In detail, the polyester floss is provided to at least one pair of perforated rollers 4 to enable the perforated rollers 4 to draw the fire-retardant agent from upper and lower sides of the polyester floss. In this respect, the perforated rollers 4 have an air suction function, and it is possible to control a suction force of the perforated rollers 4. It is preferable that two sets or more of the perforated rollers are used to draw the fire-retardant agent from the polyester floss so as to improve the drying efficiency of the drying process. The downstream perforated rollers draw a wider area than the entire polyester floss so as to ensure the fire-retardant core matrix with a desired thickness in consideration of a restoring force of the fire-retardant core matrix after suction of the perforated roller is stopped. Furthermore, a product recognition sensor and an automatic position selection system to determine positions of upper perforated rollers are installed at the perforated rollers to smoothly draw the fire-retardant agent from the polyester floss at an early stage of a suction process. In addition, it is preferable that an interval between the upstream upper and lower rollers be narrower than an interval between the downstream upper and lower rollers such that a former portion of the perforated rollers smoothly draws the fire-retardant agent and the ensuring of the desired thickness of the fire-retardant core matrix is realized at a latter portion of the perforated rollers.

After the completion of the removal of the fire-retardant agent from the polyester floss, the polyester floss is fed into a drying room. A microwave with a frequency of 2.47 GHz is irradiated to the polyester floss using a microwave generating unit 5 in the drying room to evaporate the fire-retardant agent and to dry the polyester floss. In the drying process, the fire-retardant agent acts as an adhesive when the fire-retardant agent is dried. Accordingly, the polyester floss is separated from a feeding conveyor belt 6, prior to dry the polyester floss, thereby preventing the polyester floss from being attached to the feeding conveyor belt. As for the frequency of the microwave, the microwave with a frequency of 2.47 GHz is most suitable to bring about vibration of water molecules used to dry the polyester floss. Preheated air passing through a microwave region flows through an air blowing device and an air suction device to the lower side of the polyester floss to remove steam remaining in the polyester floss during the drying process, and air upwardly flowing through the polyester floss and steam are drawn to be vented, thereby improving the drying efficiency. While the feeding conveyor belt passes through a rinsing unit installed therebeneath, alien substances are removed from a surface of the feeding conveyor belt. In the present invention, the drying process is repeated three times or more to completely dry the polyester floss.

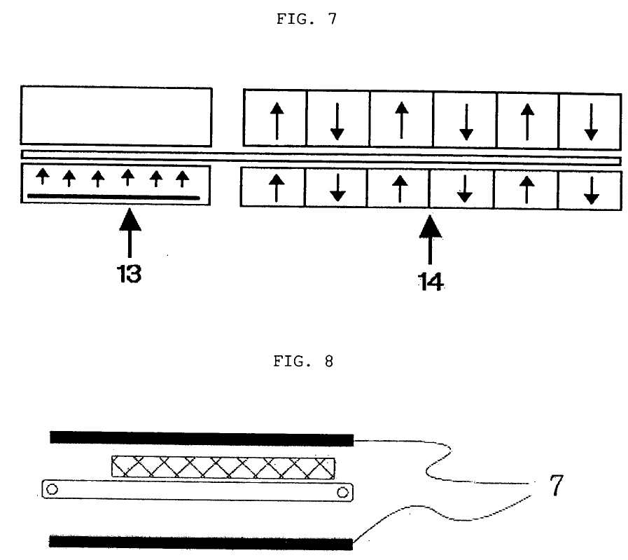

A steam chamber 13 or a hot air circulation chamber 14 may be used in addition to the microwave generating unit 5. Two or more steam chambers 13 or two or more hot air circulation chambers 14 may be sequentially arranged, or the two or more steam chambers and hot air circulation chambers 13 and 14 may be simultaneously arranged in series as shown in FIG. 7.

When the microwave generating unit is used in the drying process, two or more microwave generating units arranged in series are used to dry the polyester floss, and steam is vented using the preheated air, passing through the microwave region, through the air blowing device and air suction device at an end stage of the drying process.

When the hot air circulation chamber 14 is used in the drying process, two or more hot air circulation chambers arranged in series are used to upwardly and downwardly circulate hot air to evaporate moisture from the fire-retardant agent attached to the polyester floss to dry the polyester floss.

The dried polyester floss is foamed on a foaming conveyor belt, over which a ceramic heater or a hot air circulating heater 7 is installed. At this time, an inside of the polyester floss (a depth of 45 mm from a surface of the polyester floss) is heated and foamed, thereby accomplishing a polyester fire-retardant core matrix with high strength and low absorptivity. With respect to this, it is preferable to heat the polyester floss at 100 to 250° C. for 3 to 20 min to desirably foam the fire-retardant agent attached to the polyester floss.

The method of producing the polyester fire-retardant core matrix according to the present invention may further include sequentially RP- and trimming-processing the polyester floss using a tip-saw or a disc cutter after the drying process or after the foaming process.

In this regard, at least one step of the steps of b) to e) may be repeated two times or more to improve permeation of the fire-retardant agent into the polyester floss, drying of the polyester floss, and foaming of the polyester floss.

According to the present invention, it is possible to produce the fire-retardant core matrix with the similar strength to a glass wool by use of the polyester floss with a density of about 40 to 70 kg/m³.

Furthermore, it is possible to produce the fire-retardant core matrix having a desired level of compression strength and bending strength, capable of being used as a low density material, according to the method of the present invention.

Having generally described this invention, a further understanding can be obtained by reference to examples and comparative examples which are provided herein for the purposes of illustration only and are not intended to be limiting unless otherwise specified.

### EXAMPLE 1

A low density polyester floss as a main material was provided to a work table including upper and lower nozzle-type sprays, and 50% of fire-retardant agent was added to the polyester floss in such a way that the fire-retardant agent was sprayed onto the polyester floss using the upper and lower nozzle-type sprays to enable the fire-retardant agent to permeate into the polyester floss. At this time, the fire-retardant agent included 70% or more sodium silicate and a fire-retardant additive. Additionally, the fire-retardant additive was selected from the group consisting of sodium phosphate monobasic, magnesium hydroxide, an ester phosphate-based compound, aluminum oxide, aluminum hydroxide, antimony oxide, molybdates, and zinc tartarate. The polyester floss was then subjected to a rolling process using upper and lower rollers to promote permeation of the fire-retardant agent into the polyester floss and to increase a density of the polyester floss. A spraying process of the fire-retardant agent into the polyester floss and the rolling process were repeated two times.

The polyester floss was then provided between four pairs of perforated rollers, having inclined suction holes, to draw the fire-retardant agent from upper and lower sides of the polyester floss. In this regard, an air suction force of the perforated rollers was easily controlled. The downstream perforated roller drawn a wider area than the entire polyester floss, and a product recognition sensor and an automatic position selection system to determine positions of upper perforated rollers were installed at the perforated rollers. The semi-dried polyester floss was fed into a drying room and then irradiated by a microwave with a frequency of 2.47 GHz to evaporate the fire-retardant agent from the polyester floss and dry the polyester floss. After evaporation of the fire-retardant agent was repeated three times, the polyester floss was foamed on a foaming conveyor belt including a hot air circulation heater, thereby accomplishing a polyester fire-retardant core matrix according to the present invention.

### EXAMPLE 2

A low density polyester floss as a main material was cut using a disc cutter such that cut polyester floss has a width of 75 mm, reversed by an angle of 90 degrees using a reverse device, including a pipe twisted by the angle of 90 degrees, to allow the cut polyester floss to be vertically grained, and provided to a pipe conveyor including a set of upper and lower pipes. The polyester floss was then dipped in 50% of fire-retardant agent such that the fire-retardant agent sufficiently permeated into the polyester floss. At this time, the fire-retardant agent included 70% or more sodium silicate and a fire-retardant additive. Additionally, the fire-retardant additive was selected from the group consisting of sodium phosphate monobasic, magnesium hydroxide, an ester phosphate-based compound, aluminum oxide, aluminum hydroxide, antimony oxide, molybdates, and zinc tartarate. Bubbles and a portion of the excess fire-retardant agent was firstly removed from the polyester floss by vertically vibrating a latter end of the pipe conveyor, and the remaining fire-retardant agent was secondly removed from the polyester floss using three pairs of rollers 12, including three upper rollers encircled by a mesh belt and three lower rollers encircled by another mesh belt.

Steam was discharged onto the polyester floss using a steam chamber, and hot air at 130° C. was blown to the polyester floss using a hot air circulation chamber to sufficiently dry the polyester floss. Subsequently, the sufficiently dried polyester floss was sequentially subjected to RP and trimming processes to accomplish a vertically grained polyester fire-retardant core matrix with a density of 70 kg/m³. The polyester fire-retardant core matrix was applied to a prefabricated panel without a separate additional process, and had improved compression strength and bending strength unlike a conventional fibroid material having poor compression strength and bending strength.

As apparent from the above description, the present invention provides a method of producing a polyester fire-retardant core matrix for a prefabricated panel, which has excellent fire-retardancy, high strength and durability, low absorptivity, low density, and heavy thickness. The polyester fire-retardant core matrix according to the present invention has advantages of excellent workability, safety, and fire-retardancy. Furthermore, the method may be applied to the production of the prefabricated panel using organic materials, such as Styrofoam, without additional processes.

Additionally, in the present invention, it is possible to realize the fire-retardant core matrix having a desired level of compression strength and bending strength, capable of being used as a low density product, thereby the production costs are reduced, and adiabatic properties and weather resistance of the fire-retardant core matrix are improved due to foaming of the polyester floss.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method of producing a polyester fire-retardant core matrix for a prefabricated panel, comprising:
a) cutting a polyester floss such that the cut polyester floss has a predetermined width;
b) adding a fire-retardant agent to the cut polyester floss to allow the fire-retardant agent to permeate into the cut polyester floss, and rolling the polyester floss, drenched by the fire-retardant agent, using a roller to promote permeation of the fire-retardant agent into the polyester floss;
c) removing the excess fire-retardant agent from the polyester floss, drenched by the fire-retardant agent, using a perforated roller, of which an air suction force is easily controlled;
d) drying the polyester floss, drenched by the fire-retardant agent, using a drying unit; and
e) heating the dried polyester floss using a heater to foam the fire-retardant agent securely attached to fiber structures of the dried polyester floss.

2. The method as set forth in claim 1, wherein at least one step of the steps of b) to e) is repeated two times or more.

3. The method as set forth in claim 1, further comprising continuously reversing the cut polyester floss by an angle of 90 degrees using a reverse device, including a pipe twisted by the angle of 90 degrees, to allow the cut polyester floss to be vertically grained after the step of a).

4. The method as set forth in claim 1, further comprising sequentially RP- and trimming-processing the polyester floss using a tip-saw or a disc cutter after the step of d) or the step of e).

5. The method as set forth in claim 1, wherein the adding of the fire-retardant agent to the cut polyester floss is conducted through a spray process using upper and lower nozzles.

6. The method as set forth in claim 1, wherein the fire-retardant agent contains 5 to 30 parts by weight of fire-retardant additive, based on 100 parts by weight of sodium silicate solution, and a concentration of solids in the fire-retardant agent is 30 to 70%, the fire-retardant additive being selected from the group consisting of sodium phosphate monobasic, magnesium hydroxide, an ester phosphate-based compound, aluminum oxide, aluminum hydroxide, antimony oxide, molybdates, zinc tartarate, and a mixture thereof.

7. The method as set forth in claim 1, wherein the perforated roller in the step of c) comprises two sets or more upper and lower rollers, and an interval between the upstream upper and lower rollers is narrower than an interval between the downstream upper and lower rollers.

8. The method as set forth in claim 1, wherein the drying unit in the step of d) is one or more selected from the group consisting of a microwave generating unit, a steam chamber, a hot air circulation chamber, and a combination thereof.

9. The method as set forth in any one of claims 1 to 8, wherein two or more microwave generating units are used to dry the polyester floss in the step of d), and steam is vented using preheated air, passing through a microwave region, through an air blowing device and an air suction device at an end stage of the step of d).

10. The method as set forth in any one of claims 1 to 8, wherein two or more hot air circulation chambers are used in the step of d) to upwardly and downwardly circulate hot air to evaporate moisture from the fire-retardant agent attached to the polyester floss to dry the polyester floss.

11. The method as set forth in claim 1, wherein the heater used in the step of e) is a ceramic heater or a hot air circulation heater, and the polyester floss is heated at 150 to 250° C. for 3 to 20 min to foam the fire-retardant agent attached to the polyester floss.
